(19) United States
(12) Patent Application Publication
(10) Pub. No.: US 2004/0017471 A1
(43) Pub. Date: Jan. 29, 2004

(54) Remote monitoring transmitter, remote monitoring receiver, and remote monitoring system

(76) Inventors: Ryoichi Suga, Kanagawa (JP); Minako Takeishi, Kanagawa (JP); Ryohei Okada, Tokyo (JP); Takeshi Fujimori, Tokyo (JP)

Correspondence Address: William S. Frommer, Esq., FROMMER LAWRENCE & HAUG LLP, 745 Fifth Avenue, New York, NY, 10151, US

(21) Appl. No.: 10/421,100

(22) Filed: Apr. 23, 2003

(30) Foreign Application Priority Data
Apr. 24, 2002 (JP) 2002-122965

(51) Int. Cl. H04N 7/18

(52) U.S. Cl. 348/143

(57) ABSTRACT

Disclosed herein are a remote monitoring transmitter, a remote monitoring receiver and a remote monitoring system. A remote monitoring transmitter includes a video input terminal; video compressing means for compressing at a variable compression ratio video data input through the video input terminal; a communication interface for conducting communications over a network; and controlling means for causing the video compressing means to control the compression ratio based upon receipt by the communication interface of control data for controlling the compression ratio for the video data; in which video data compressed by the video compressing means are transmitted through the communication interface.

### BACKGROUND OF THE INVENTION

The present invention relates to a remote monitoring transmitter, a remote monitoring receiver and a remote monitoring system. More particularly, the invention relates to a remote monitoring transmitter, a remote monitoring receiver and remote monitoring system designed to reduce the space they occupy when installed and to lower the cost of communications effected thereby.

Factories, shops, offices and other installations often need to be monitored from a remote location for possible crimes and fires. In such cases, it is very effective for personnel manning the monitoring post to verify visually and in real time what is happening at the sites being surveyed.

Such monitoring setups have been widely implemented using a remote monitoring system. Typically, the system involves connecting the installations under surveillance (called the remote locations hereunder) with the post that monitors these locations (called the monitoring center hereunder) by means of a network. A surveillance video camera set up at each remote location sends currently-taken pictures to the monitoring center where the pictures are displayed on monitors for verification.

FIG. 1 shows a typical overall configuration of a conventional remote monitoring system. In FIG. 1, a plurality of remote locations 101 (101-1 through 101-N) are each equipped with a video camera 51 and a remote monitor station (i.e., transmitter) 52.

A monitoring center 102 in FIG. 1 includes remote monitor stations (receivers) 53 (53-1 through 53-N) corresponding to the remote monitor stations 52 at the remote locations 101 on a one-to-one basis (i.e., there are as many remote monitor stations 53 as the remote locations 101). Also set up in the monitoring center 102 are a video split display unit 54 and a monitor 55.

The remote monitor stations 52 at the remote locations 101 are connected with the corresponding remote monitor stations 53 in the monitoring center 102 illustratively via an intranet such as a WAN (wide area network) 103.

FIG. 2 depicts a typical structure of the remote monitor station 52 at each remote location 101. In FIG. 2, the remote monitor station 52 comprises: a video input terminal 61; an A/D converter 62; a video compression block 63 for compressing digital video signals; and a communication interface 64 for communication over the network.

The video compression block 63 is designed to compress digital video signals at predetermined compression ratios (i.e., at predetermined quantization steps, bit rate, and frame rate). The compression ratios are set at values low enough to permit illustratively a full-screen display of decompressed video data with little loss in picture quality.

FIG. 3 indicates a typical structure of each remote monitor station 53 in the monitoring center 102. In FIG. 3, the remote monitor station 53 includes: a communication interface 71 for communication over the network; a video decompression block 72; a D/A converter 73; and a video output terminal 74.

The video split display unit 54 in the monitoring center 102 is designed to process video signals from a plurality of signal processing blocks in a way allowing pictures represented by these video signals to be split into unit areas for display on a single screen.

At each remote location 101, the video signal coming from the video camera 51 is input through the video input terminal 61 to the remote monitor station 52. The input video signal is digitized by the A/D converter 62 before being compressed by the video compression block 63 at a predetermined compression ratio. The compressed video data coming from the video compression block 63 are transmitted through the communication interface 64 of the remote monitor station 52 to the corresponding remote monitor station 53 in the monitoring center 102 over the WAN 103.

In the monitoring center 102, the compressed video data sent from the remote monitor station 52 at each remote location 101 are received through the communication interface 71 of the corresponding remote monitor station 53. In each remote monitor station 53, the compressed video data are decompressed by the video decompression block 72, converted to analog form by the D/A converter 73, and output from the video output terminal 74 for transmission to the video split display unit 54.

Given the video data from each remote monitor station 53, the video split display unit 54 generates video signals for a split-area picture display on one screen.

In the manner described, the pictures taken by the video cameras 51 at the remote locations 101 are displayed simultaneously in divided areas on the single screen of the monitor 55 in the monitoring center 102.

The conventional remote monitoring system outlined above with reference to FIGS. 1 through 3 is known to have the following three major problems:

(1) In the monitoring center 102, the remote monitor stations 53 are set up corresponding to the remote monitor stations 52 at the remote locations 101 on a one-to-one basis. That means the larger the number of remote locations 101 to be surveyed, the larger the number of remote monitor stations 53 to be established in the monitoring center 102. As a result, the monitoring center 102 needs to set aside a growing space in which to install the facilities. The monitoring center 102 also dissipates more power and requires more complicated wiring the larger the number of remote monitor stations to be set up.

(2) The video split display unit 54 is established independently of the remote monitor stations 53 in the monitoring center 102. This adds further to the growing space in which to install the facilities.

(3) Large quantities of video data compressed at relatively low compression ratios are constantly sent from the remote monitor stations 52 at the remote locations 101 to the corresponding remote monitor stations 53 in the monitoring center 102 by way of the WAN 103. That means the intensity of traffic over the WAN 103 is high, and so is the cost of communications. The intense traffic can translate into considerable delays before the pictures taken in real time by the video cameras 51 at the remote locations 101 can be displayed on the monitor 55 in the monitoring center 102. In that case, the displayed pictures may not be effective as a real-time indication.

### SUMMARY OF THE INVENTION

The present invention has been made in view of the above circumstances and provides a remote monitoring transmitter, a remote monitoring receiver and a remote monitoring system whereby the space for installing equipment in the monitoring center is reduced, power consumption by the monitoring center is lowered, the wiring required of the center is simplified, the communication costs involved are reduced, and the transmitted pictures are displayed in real time.

In carrying out the invention and according to a first aspect thereof, there is provided a remote monitoring transmitter including: a video input terminal; video compressing means for compressing at a variable compression ratio video data input through the video input terminal; a communication interface for conducting communications over a network; and controlling means for causing the video compressing means to control the compression ratio based upon receipt by the communication interface of control data for controlling the compression ratio for the video data; in which video data compressed by the video compressing means are transmitted through the communication interface.

Preferably, the video compressing means varies the compression ratio by having a quantization step value updated.

Preferably, video data furnished with an address header including an IP address of a receiver are transmitted through the communication interface.

According to a second aspect of the invention, there is provided a remote monitoring receiver including: a communication interface for conducting communications over a network; a plurality of video decompressing means for decompressing a plurality of sets of video data received through the communication interface; video splitting means which, given the plurality of sets of video data decompressed by the video decompressing means, generates video data in such a manner as to display pictures constituted by the decompressed video data in split-area fashion on a single monitor screen; a video output terminal for outputting the video data generated by the video splitting means; operating means for selecting any of the video data representative of the plurality of sets of video data for an enlarged display on the single monitor screen; and controlling means which, based on operations performed on the operating means, controls the video splitting means and transmits through the communication interface control data for controlling a compression ratio for the video data.

Preferably, the controlling means transmits as the control data those for updating a quantization step value.

Preferably, video data furnished with an address header including an IP address of the remote monitoring receiver are received through the communication interface.

According to a third aspect of the invention, there is provided a remote monitoring system including a plurality of remote monitoring transmitters and a remote monitoring receiver; in which each of the remote monitoring transmitters includes: a video input terminal; video compressing means for compressing at a variable compression ratio video data input through the video input terminal; a communication interface for conducting communications over a network; and controlling means for causing the video compressing means to control the compression ratio based upon receipt by the communication interface of control data for controlling the compression ratio for the video data; in which video data compressed by the video compressing means are transmitted through the communication interface over the network to the remote monitoring receiver; in which the remote monitoring receiver includes: a communication interface for conducting communications over the network; a plurality of video decompressing means which correspond to the remote monitoring transmitters on a one-to-one basis and which decompress a plurality of sets of video data received through the communication interface from the remote monitoring transmitters; video splitting means which, given the plurality of sets of video data decompressed by the video decompressing means, generates video data in such a manner as to display pictures constituted by the decompressed video data in split-area fashion on a single monitor screen; a video output terminal for outputting the video data generated by the video splitting means; operating means for selecting any of the video data representative of the plurality of sets of video data for an enlarged display on the single monitor screen; and controlling means which, based on operations performed on the operating means, controls the video splitting means and transmits through the communication interface control data for controlling the compression ratio for the video data.

Preferably, the video compressing means of each of the remote monitoring transmitters varies the compression ratio by having a quantization step value updated; and in which the controlling means of the remote monitoring receiver transmits as the control data those for updating the quantization step value.

Other objects, features and advantages of the invention will become more apparent upon a reading of the following description and appended drawings.

### BRIEF DESCRIPTION OF THE DRAWINGS

FIG. 1 is a schematic view showing a typical overall configuration of a conventional remote monitoring system;

FIG. 2 is a schematic view depicting a typical structure of a remote monitor station (transmitter) in the system of FIG. 1;

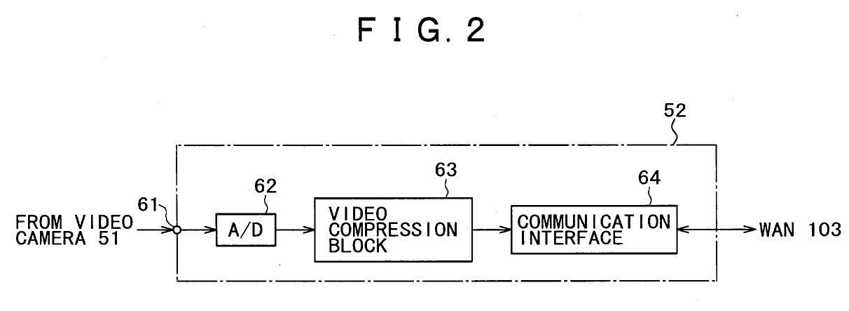

FIG. 3 is a schematic view illustrating a typical structure of a remote monitor station (receiver) in the system of FIG. 1;

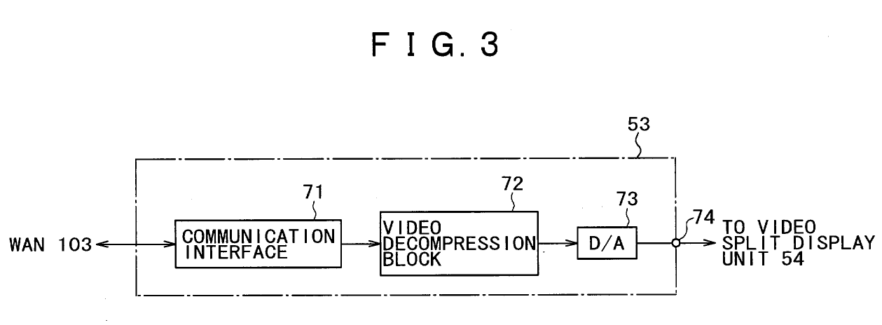

FIG. 4 is a schematic view indicating a typical overall configuration of a remote monitoring system embodying this invention;

FIG. 5 is a schematic view presenting a typical structure of a remote monitoring transmitter in the system of FIG. 4;

FIG. 6 is a schematic view sketching a typical structure of a remote monitoring receiver in the system of FIG. 4;

FIG. 7 is a schematic view showing how a display screen is split into areas by a video split display block in the remote monitoring receiver of FIG. 6;

FIG. 8 is a flowchart of steps performed by a remote monitoring transmitter in the system of FIG. 4; and

FIG. 9 is a flowchart of steps carried out by the remote monitoring receiver in the system of FIG. 4.

### DESCRIPTION OF THE PREFERRED EMBODIMENTS

Preferred embodiments of this invention will now be described with reference to the accompanying drawings.

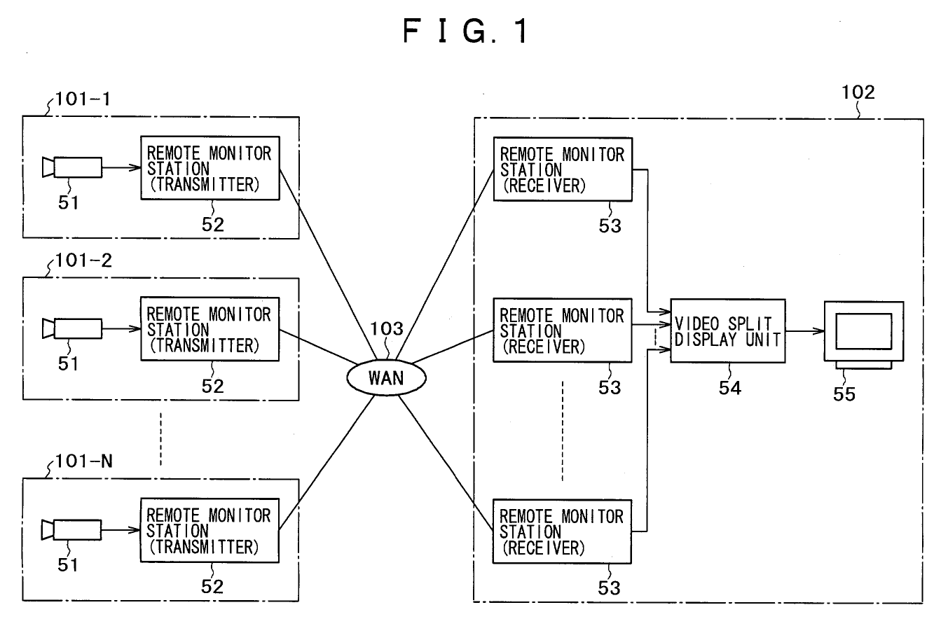

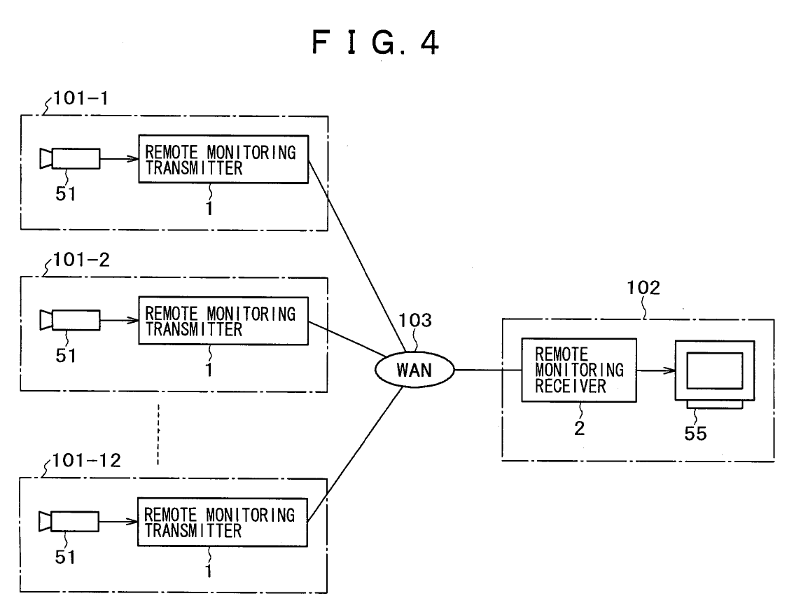

FIG. 4 shows a typical overall configuration of a remote monitoring system embodying this invention. In FIG. 4, those components of the system which have their functionally equivalent counterparts in FIG. 1 are designated by like reference numerals. In FIG. 4, each of 12 remote locations 101 (101-1 through 102-12) is furnished with a video camera 51 and a remote monitoring transmitter 1 admitting video signals from the video camera 51.

A monitoring center 102 is equipped with a remote monitoring receiver 2 and a monitor 55 admitting output video signals from the receiver 2.

The remote monitoring transmitter 1 at each remote location 101 is connected via a WAN (wide area network) 103 to the remote monitoring receiver 2 in the monitoring center 102.

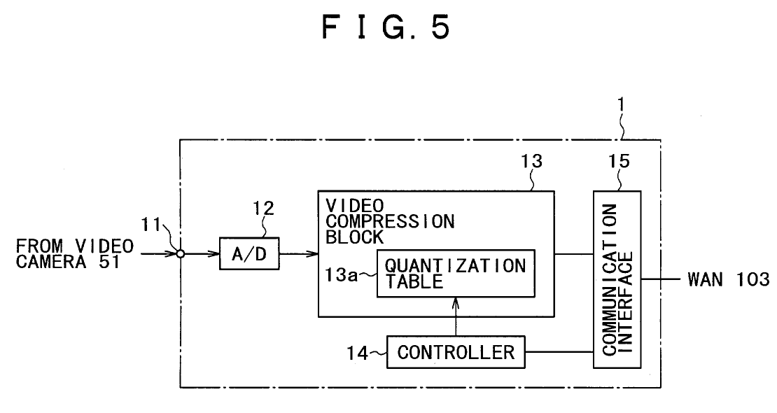

FIG. 5 depicts a typical structure of the remote monitoring transmitter 1 at each remote location 101. In FIG. 5, the remote monitoring transmitter 1 includes: a video input terminal 11 for admitting video signals from the video camera 51, an A/D converter 12 for converting the video signal from the video input terminal 11 into digital form; a video compression block 13 for compressing the digital video signal from the A/D converter 12; a controller 14 made of a microprocessor; and a communication interface 15 operating in accordance with TCP/IP as the communication protocol in effect.

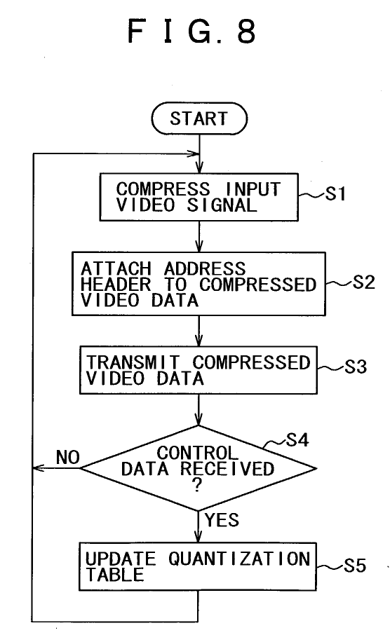

The video compression block 13 is designed to compress digital video signals using a teleconference encoding format H.263. The video compression block 13 contains a compression ratio table that defines the values of quantization steps, bit rates, and frame rates. The compression ratio table includes a quantization table 13a that defines the values of quantization steps, and these values may be updated. Updating the quantization table 13a as needed enables the compression ratios of video signals to be changed. The values in the quantization table 13a are updated under control of the controller 14, as will be described later with reference to the flowchart of FIG. 8.

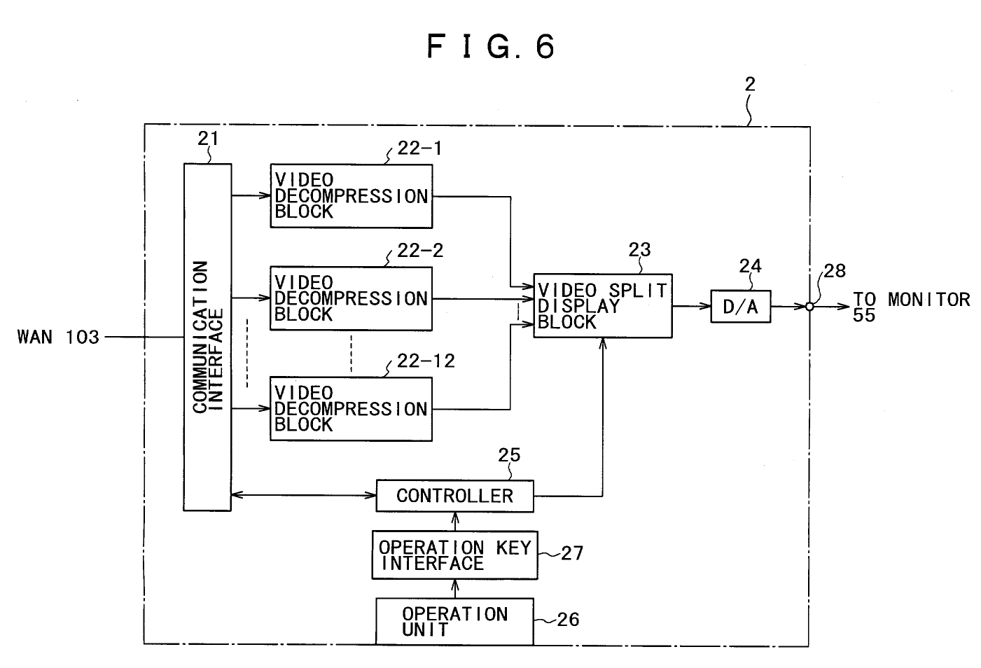

FIG. 6 shows a typical structure of the remote monitoring receiver 2 in the monitoring center 102. In FIG. 6, the remote monitoring receiver 2 comprises: a communication interface 21 operating in accordance with TCP/IP as the communication protocol in effect; 12 video decompression blocks 22 (22-1 through 22-12) for decompressing the compressed video data received through the communication interface 21; a video split display block 23 for admitting output video signals from the video decompression block 22; a D/A converter 24 for converting the output video signal from the video split display block 23 into analog form; a controller 25 made of a microprocessor; an operation unit 26 furnished on the surface of the receiver 2; an operation key interface 27; and a video output terminal 28 for outputting the analog video signal coming from the D/A converter 24.

The video decompression blocks 22-1 through 22-12 are designed to decompress compressed video data using the format H.263. The blocks 22-1 through 22-12 correspond to the remote monitoring transmitters 1 at the remote locations 101-1 through 101-12 respectively, each decompression block being provided with an IP address.

The video split display block 23 is designed to generate video signals in a way allowing the signals from the video decompression blocks 22 to be displayed in split areas on a single screen.

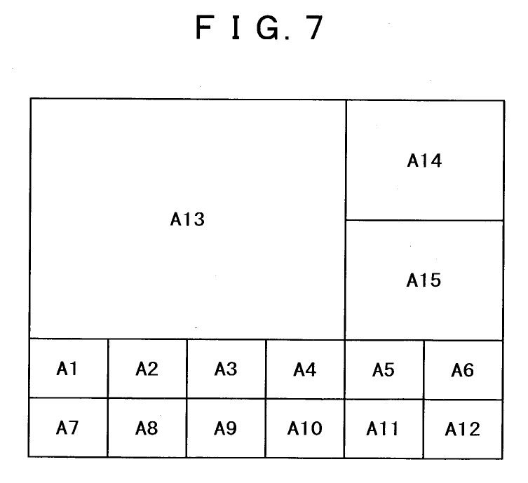

FIG. 7 is a schematic view illustrating how the screen is typically divided for display by the video split display block 23. The screen is split illustratively into 6 columns and 6 rows to form 36 unit areas. Twelve areas Al through A12 in the first and the second rows from the bottom of the screen are used to display pictures reflecting the video signals from the video decompression blocks 22-1 through 22-12 (i.e., pictures taken by the video cameras 51 at the remote locations 101-1 through 101-12).

Sixteen unit areas formed by the first through the fourth columns from left and by the first through the fourth rows from the top make up an area A13. This area A13 is used to display selectively the picture represented by the video signal from any one of the video decompression blocks 22 (i.e., picture taken by the video camera 51 at any one of the remote locations 101-1 through 101-12).

Four unit areas formed by the first and the second columns from right and by the first and the second rows from the top constitute an area A14, and another four unit areas made up of the first and the second columns from right and by the third and the fourth rows from the top form an area A15. The two areas A14 and A15 are each used to display the picture reflecting the video signal from one of the video compression blocks 22 which is different from the one whose picture is being shown in the area Al (i.e., picture taken by the video camera 51 at a remote location 101 different from the location whose picture is shown in the area A1).

The video signal is not subject to pixel skipping for display in the area A13 but is made to undergo 1/16 pixel skipping, using a memory in the video split display block 23, for display in any one of the unit areas A1 through A12. The video signal is not subject to pixel skipping for display in the area A14 or A15 but is made to undergo ¼ pixel skipping in like manner for display in any one of the unit areas Al through A12.

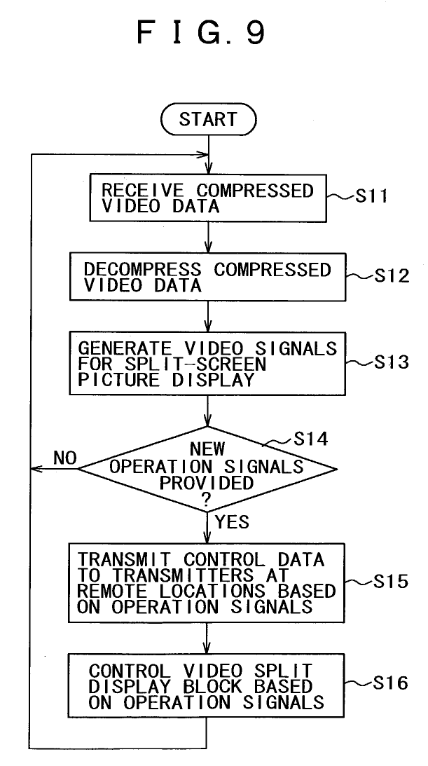

Which of the video signals from the video decompression blocks 22 are directed for display in the areas A13, A14 and A15 will be determined under control of the controller 25, as will be described later with reference to the flowchart of FIG. 9.

The operation unit 26 has operation keys, not shown, manipulated so as to determine which of the video signals from the 12 remote locations 101 are to be displayed in the areas A13, A14 and A15 (in FIG. 7) on the screen of the monitor 55.

Manipulating the operation keys on the operation unit 25 causes an operation signal representing the key operation to be sent to the controller 25 through the operation key interface 27.

FIG. 8 is a flowchart of steps performed by the remote monitoring transmitter 1 at each remote location 101. In step S1 of FIG. 8, a video signal coming from the video camera 51 and input through the video input terminal 11 is digitized by the A/D converter 12 before being compressed by the video compression block 13 referencing the compression ratio table.

In step S2, the compressed video data from the video compression block 13 are sent to the communication interface 15. There, the controller 14 furnishes the compressed video data with an address header containing the IP address of the video decompression block 22 corresponding to this remote monitoring transmitter 1 (e.g., in the case of the remote monitoring transmitter 1 at the remote location 101-1, the IP address of the video decompression block 22-1 is attached to the address header).

In step S3, the compressed video data furnished with the address header are transmitted from the communication interface 15 over the WAN 103 to the remote monitoring receiver 2 in the monitoring center 102.

In step S4, the controller 14 determines whether Telnet protocol control data from the remote monitoring receiver 2 in the monitoring center 102 have been received anew by the communication interface 15 over the WAN 103, the control data being used to update the quantization step values in the quantization table 13a inside the video compression block 13 (i.e., to control the video signal compression ratio in the video compression block 13).

If no control data are judged to be received anew in step S4, then step S1 is reached again, and steps S1 through S4 are repeated.

If in step S4 the control data are judged to be received anew, then step S5 is reached. In step S5, the controller 14 causes the video compression block 13 to update the quantization step values in the quantization table 13a on the basis of the received control data. From step S5, procedure is returned to step S1.

In step S1 following step S5, the video compression block 13 compresses the video signal by referencing the compression ratio table containing the quantization table 13a updated in step S5.

FIG. 9 is a flowchart of steps carried out by the remote monitoring receiver 2 in the monitoring center 102. In step S11 of FIG. 9, compressed video data sent from the remote monitoring transmitter 1 at each remote location 101 to the remote monitoring receiver 2 over the WAN 103 are received by the communication interface 21.

The compressed video data from each remote monitoring transmitter 1 are furnished with an address header containing the IP address designating the video decompression block 22 corresponding to the transmitter in question. In step S12, the communication interface 21 referencing the IP address in the header forwards the compressed video data to the corresponding video decompression block 22 (e.g., in the case of the remote monitoring transmitter 1 at the remote location 101-1, the data are sent to the video decompression block 22-1) for data decompression.

In step S13, the video split display block 23 admitting decompressed video signals from the video decompression blocks 22 generates video signals for displaying, in a split manner as shown in FIG. 7, the pictures constituted by the signals from the blocks 22. The generated video signals are converted to analog form by the D/A converter 24 before being output through the video output terminal 28 to the monitor 55.

In step S14, the controller 25 determines whether any operation signals are sent anew from the operation unit 26 through the operation key interface 27. If no operation signal is judged to be sent anew in step S14, then step S11 is reached again, and step S11 through S13 are repeated.

If in step S14 new operation signals are judged to be sent from the operation unit 26, then step S15 is reached. In step S15, the controller 25 causes the communication interface 21 to transmit control data (a), (b) and (c) described below, using the Telnet protocol, to specific remote monitoring transmitters based on the operation signals. The operation signals are assumed here to specify that the remote monitoring transmitters 1 at some remote location 101 be selected anew to have their pictures displayed in the areas A13, A14 and A15 in FIG. 7, and that the remote monitoring transmitters 1 at other remote locations 101 be selected anew to have their pictures removed from the areas A13, A14 and A15 (where their pictures have been shown). The three kinds of control data are defined illustratively as follows:

The control data (a) are provided for that remote monitoring transmitter 1 at one remote location 101 which is selected anew to have its picture displayed in the area A13 of FIG. 7. The data (a) are used to update the quantization step values in the quantization table 13a in the video compression block 13 (i.e., to modify the compression ratio of the video signal) in a manner causing a decompressed video signal from the video decompression block 22 to become a 4CIF format (a format four times the CIF, with a luminance signal of 704×576 pixels) video signal.

The control data (b) are provided for those remote monitoring transmitters 1 at other remote locations 101 which are selected anew to have their pictures displayed in the areas A14 and A15 of FIG. 7. The data (b) are used to update the quantization step values in a manner causing decompressed video signals from the respective video decompression blocks 22 to become a CIF format (with a luminance signal of 352×288 pixels) video signal each.

The control data (c) are provided for those remote monitoring transmitters 1 at other remote locations 101 which are selected anew to have their pictures displayed only in the areas A1 through A12 of FIG. 7. The data (c) are used to update the quantization step values in a manner causing decompressed video signals from the respective video decompression blocks 22 to become a QCIF format (a quarter of the CIF format, with a luminance signal of 176×144 pixels) video signal each.

In step S16, the controller 25 receiving operation signals from the operation unit 26 controls the video split display block 23 accordingly. More specifically, the controller 25 causes the video split display block 23 to define the areas A13, A14 and A15 in FIG. 7 as the areas in which to display the pictures from the remote monitoring transmitters 1 at the remote locations 101 selected by the operation unit 26 for such picture display represented by the video signals from the respective video decompression blocks 22. From step S16, control is returned to step S11.

Although not shown in FIG. 9, the controller 25 in its initial state (i.e., where operation signals have yet to be sent from the operation unit 26) transmits control data (d) through (f) defined below, using the Telnet protocol, from the communication interface 21 to the remote monitoring transmitters 1 at the remote locations 101 over the WAN 103. At the same time, the controller 25 causes the video split display block 23 to define the areas A13, A14 and A15 in FIG. 7 as the areas in which to display the pictures represented by the video signals from the video decompression blocks 22-1, 22-2 and 22-3 corresponding to the remote monitoring transmitters 1 at the remote locations 101-1, 101-2 and 101-3, respectively. The three more kinds of control data are defined illustratively as follows:

The control data (d), provided for the remote monitoring transmitter 1 at the remote location 101-1, are used to update the quantization step values in the quantization table 13a in the video compression block 13 in a manner causing the corresponding decompressed video signal from the video decompression block 22 to become a 4CIF format video signal.

The control data (e), provided for the remote monitoring transmitters 1 at the remote locations 101-2 and 101-3, are used to update the quantization step values in a manner causing the corresponding decompressed video signals from the video decompression blocks 22 to become a CIF format video signal each.

The control data (f), provided for the remote monitoring transmitters 1 at the remote locations 101-4 through 101-12, are used to update the quantization step values in a manner causing the corresponding decompressed video signals from the video decompression blocks 22 to become a QCIF format video signal each.

What follows is a description of how the inventive remote monitoring system compresses, transmits, receives and displays pictures taken at the remote locations.

Before any personnel in the monitoring center 102 manipulate the operation unit 26 of the remote monitoring receiver 2, the initial settings in place as described above allow the remote monitoring transmitter 1 at each remote location 101 to receive the corresponding control data. That is, the remote monitoring transmitter 1 at the remote location 101-1 receives the control data for updating the quantization step values in a manner turning the corresponding decompressed video signal into a 4CIF format video signal; the remote monitoring transmitters 1 at the remote locations 101-2 and 101-3 receive the control data for updating the quantization step values in a manner turning the corresponding decompressed video signals into a CTF format video signal each; and the remote monitoring transmitters 1 at the remote locations 101-4 through 101-12 receive the control data for updating the quantization step values in a manner turning the corresponding decompressed video signals into a QCIF format video signal each.

Based on the received control data, the remote monitoring transmitter 1 at each remote location 101 updates the quantization step values in the quantization table 13a inside the video compression block 13 (in steps S4 and S5 of FIG. 8). By referencing the compression ratio table containing the updated quantization table 13a, the video compression block 13 compresses the video signal (in step S1 of FIG. 8).

As a result, the remote monitoring transmitter 1 at the remote location 101-1 has its video signal compressed at a relatively low compression ratio; the remote monitoring transmitters 1 at the remote locations 101-2 and 101-3 have their video signals compressed at a somewhat higher compression ratio; and the remote monitoring transmitters 1 at the remote locations 101-4 through 101-12 have their video signals compressed at an even higher compression ratio.

The remote monitoring transmitter 1 at each remote location 101 transmits the video data thus compressed to the remote monitoring receiver 2 in the monitoring center 102 over the WAN 103 (in step S2 and S3 of FIG. 8).

Consequently, the remote monitoring transmitter 1 at the remote location 101-1 sends relatively large quantities of video data; the remote monitoring transmitters 1 at the remote locations 101-2 and 101-3 send somewhat smaller quantities of video data; and the remote monitoring transmitters 1 at the remote locations 101-4 through 101-12 send even less quantities of video data.

In this setup, the intensity of traffic over the WAN 103 is appreciably lower than if relatively large quantities of video data were sent from the remote monitoring transmitters 1 at all remote locations 101.

At the remote monitoring receiver 2 in the monitoring center 102, the compressed video data received from the remote monitoring transmitters 1 at the remote locations 101-1 through 101-12 are decompressed by the respective video decompression blocks 22-1 through 22-12 (in steps S11 and S12 of FIG. 9).

With the above-described initial settings in place, the video split display block 23 generates video signals defining the areas A13, A14 and A15 in FIG. 7 as the areas in which to display the pictures constituted by the video signals from the video decompression blocks 22-1, 22-2 and 22-3 respectively, so that the pictures may be displayed in split fashion in unit areas on a single screen. The generated video signals are converted to analog form by the D/A converter 24 before being output to the monitor 55 through the video output terminal 28 (in step S13 of FIG. 9).

In turn, the monitor 55 provides a picture display as follows: the picture taken by the video camera 51 at the remote location 101-1 is displayed in the area A13 of FIG. 7 in the 4CIF format; the pictures taken by the video cameras 51 at the remote locations 101-2 and 101-3 are displayed in the areas A14 and A15 in FIG. 7 respectively in the CIF format; and the pictures taken by the video cameras 51 at the remote locations 101-4 through 101-12 are displayed in the areas A4 through A12 of FIG. 7 respectively in the QCIF format.

Suppose that an operator in the monitoring center 102 has decided to verify in more detail the situations at the remote locations 101-4 through 101-6. In that case, the operator manipulates the operation unit 26 of the remote monitoring receiver 2 selectively to display the pictures from the remote locations 101-4, 101-5 and 101-6 in the areas A13, A14 and A15 of FIG. 7, respectively.

In turn, the remote monitoring receiver 2 transmits relevant control data to the remote monitoring transmitters 1 at the remote locations 101 involved. More specifically, the remote monitoring transmitter 1 at the remote location 101-4 selected anew to have its picture displayed in the area A13 are now supplied with the control data for updating the quantization step values in a manner causing the corresponding decompressed video signal to become a 4CIF format video signal; the remote monitoring transmitters 1 at the remote location 101-5 and 101-6 selected anew to have their pictures displayed in the areas A14 and A15 are supplied with the control data for updating the quantization step values in a manner causing the corresponding decompressed video signals to become a CIF format video signal each; and the remote monitoring transmitters 1 at the remote location 101-1 through 101-3 selected anew to have their pictures displayed only in the areas A1 through A12 are supplied with the control data for updating the quantization step values in a manner causing the corresponding decompressed video signals to become a QCTF format video signal each (in step S15 of FIG. 9).

The video split display block 23 then defines the areas A13, A14 and A15 as the areas in which to display the pictures represented by the video signals from the video decompression blocks 22 corresponding to the remote monitoring transmitters 1 at the remote locations 101-4, 101-5 and 101-6 respectively (in step S16 of FIG. 9).

The remote monitoring transmitters 1 at the remote locations 101-1 through 101-6 receive the respective control data anew from the remote monitoring receiver 2 in the monitoring center 102. Based on the received control data, the remote monitoring transmitter 1 at each remote location 101 updates the quantization step values in the quantization table 13a inside the video compression block 13 (in steps S4 and S5 of FIG. 8). By referring to the compression ratio table containing the updated quantization table 13a, each video compression block 13 compresses the video signal (in step S1 of FIG. 8).

As a result, the remote monitoring transmitters 1 at the remote locations 101-1 through 101-3 have their video signals compressed at a higher compression ratio, while the remote monitoring transmitters 1 at the remote locations 101-4 through 101-6 have their video signals compressed now at a lower compression ratio.

From the remote monitoring transmitters 1 at the remote locations 101-4 through 101-6, the video data thus compressed are sent to the remote monitoring receiver 2 in the monitoring center 102 over the WAN 103 (in steps S2 and S3 of FIG. 8).

Meanwhile, the remote monitoring transmitters 1 at the remote locations 101-7 through 101-12 cause their video compression blocks 13 to compress the video data by referencing the same compression ratio table as before, and transmit their compressed video data to the remote monitoring receiver 2 in the monitoring center 102 over the WAN 103 (in steps S1 through S3 of FIG. 8).

Consequently, the remote monitoring transmitter 1 at the remote location 101-4 sends relatively large quantities of video data; the remote monitoring transmitters 1 at the remote locations 101-5 and 101-6 send somewhat smaller quantities of video data; and the remote monitoring transmitters 1 at the remote locations 101-1 through 101-3 and 101-7 through 101-12 send even less quantities of video data.

In this setup, the intensity of traffic over the WAN 103 is appreciably lower than if relatively large quantities of video data were transmitted from the remote monitoring transmitters 1 at all remote locations 100.

The remote monitoring receiver 2 in the monitoring center 102 causes the compressed video data received from the remote monitoring transmitters 1 at the remote locations 101-1 through 101-12 to be decompressed by the corresponding video decompression blocks 22-1 through 22-12 (in steps S11 and S12 of FIG. 9).

In step S16 of FIG. 9, the video split display block 23 generates relevant video signals causing the pictures constituted by the video signals from the video decompression blocks 22-4, 22-5 and 22-6 to be displayed respectively in the areas A13, A14 and A15 defined for the split-area display on the single screen as shown in FIG. 7. The generated video signals are converted to analog form by the D/A converter 24 before being output through the video output terminal 28 to the monitor 55 (in step S13 of FIG. 9).

The monitor 55 then enables those pictures from the remote locations 101-4, 101-5 and 101-6, which were displayed only in the areas A4, A5 and A6 in FIG. 7 before, to be now displayed in an enlarged manner in the areas A13, A14 and A15 as well, respectively.

The personnel in the monitoring center 102 are then able to scrutinize the enlarged pictures in the areas A13 through A15 of the screen detailing the situations at the remote locations 101-4 through 101-6.

With the inventive remote monitoring system in place as described above, an operator at the operation unit 26 of the remote monitoring receiver 2 in the monitoring center 102 is allowed to make operations determining which of the pictures from the 12 remote locations 101 are to be selected for enlarged display. When the selective operations are carried out, the remote monitoring receiver 2 controls the video split display block 23 accordingly and transmits control data for suitably controlling the video signal compression ratios to the remote monitoring transmitters 1 at the remote locations 101.

Given the control data, the remote monitoring transmitters 1 at the remote locations 101 cause the video compression blocks 13 to vary correspondingly the compression ratios for input video signals. The video data compressed at the newly varied compression ratios are sent from the remote monitoring transmitters 1 at the remote locations 101 to the remote monitoring receiver 2 in the monitoring center 102.

The pictures from those locations selected out of the 12 remote locations 101 under surveillance are then displayed in magnified fashion (e.g., in areas A13 through A15 of FIG. 7) on the single screen of the monitor 55 in the monitoring center 102. At the same time, the compression ratios of the video data being sent from the remote monitoring transmitters 1 at the other remote locations 101 are adjusted so as to reduce the traffic over the WAN 103.

The reduced intensity of traffic over the WAN 103 translates into lower communication costs while allowing the pictures currently taken by the video cameras 51 at the remote locations 101 to be displayed with little delay on the monitor 55 in the monitoring center 102 (i.e., the real-time nature of the displayed pictures is ensured).

The compression ratios for the pictures to be enlarged on the screen of the monitor 55 are lowered while the pictures to be displayed small on the screen (i.e., in the areas A1 through A12 of FIG. 7) have their compression ratios increased. That means the intensity of traffic over the WAN 103 is lowered but little degradation is experienced in the quality of pictures appearing on the monitor 55.

Where the remote monitoring system of this invention is set up, the remote monitoring receiver 2 in the monitoring center 102 comprises a plurality of video decompression blocks 22 which correspond to the remote monitoring transmitters 1 at the remote locations 101 on a one-to-one basis and which decompress the video data received from the corresponding transmitters 1. The video split display block 23 is also included in the remote monitoring receiver 2.

This structure is characterized in that only one remote monitoring receiver needs to be installed in the monitoring center 102 and that there is no need to furnish the monitoring center 102 with a video split display device apart from the receiver. These features translate into less space needed for installing facilities in the monitoring center 102, reduced power dissipation of the center, and simplified wiring arrangements at the site of the center 102.

In the examples discussed above, the video split display block 23 of the remote monitoring receiver 2 in the monitoring center 102 was shown to output only the video signals such as to have the pictures from the remote locations 101 displayed in split fashion as shown in FIG. 7.

As an alternative, in addition to the video signals above, the video split display block 23 may output a video signal causing that picture from the remote location 101 which is shown in, say, the area A13 of FIG. 7 to be displayed full-screen. That additional video signal may be sent from the remote monitoring receiver 2 to another monitor apart from the monitor 55. As another alternative, the selected picture may be displayed full-screen on the monitor 55 as shown in the area A13. In this case, the video split display state may be restored by suitably manipulating the operation unit 26.

The alternative structures above allow the picture from any desired remote location 101 to be displayed in the full screen format on the monitor in the monitoring center 102. The magnified display permits detailed visual checks on the situation at the remote location 101 in question.

In the examples above, the video split display block 23 was shown splitting the screen as depicted in FIG. 7. Alternatively, the video split display block 23 may split the screen in any other manner, as long as it allows the picture from any remote location 101 selected by the operation unit 26 to be displayed larger than the pictures from the other remote locations 101.

In the above examples, the quantization step values were shown updated in the video compression block 13 of the remote monitoring transmitter 1 at each remote location 101, so as to vary the corresponding compression ratio for the video signal in effect.

As an alternative, the bit rate or frame rate values instead of the quantization step values may be updated to modify the compression ratios for the video signals. The pictures shown in the areas A13, A14 and A15 may be omitted from the highly-compressed display in the A1-A12 display field or may be given a suitable sign each in that field indicating they are being displayed magnified in the areas A13, A14 and A15.

As described, the inventive remote monitoring system, which allows video data to be sent from a plurality of remote locations over a network to the monitoring center for display on a monitor, adjusts the compression ratios for the video data transmitted from the remote monitoring transmitters at these remote locations in such a manner as to lower the intensity of traffic over the network. This reduces communication costs while enabling the pictures currently taken at the remote locations to be displayed on the monitor screen of the monitoring center with little delay.

The remote monitoring system of the invention lowers the compression ratio for desired video data to be enlarged for split-area display on a single screen, and increases the ratios for the other video data to be displayed smaller also in split-area fashion on that screen. This makes it possible to prevent degradation in the quality of the pictures being displayed on the monitor.

According to the invention, the monitoring center need only have one remote monitoring receiver. Furthermore, there is no need for the monitoring center to be equipped with a video split display device apart from the remote monitoring receiver. These features translate into less space needed for installing facilities in the monitoring center, reduced power dissipation of the center, and simplified wiring arrangements at the site of the center.

As many apparently different embodiments of this invention may be made without departing from the spirit and scope thereof, it is to be understood that the invention is not limited to the specific embodiments thereof except as defined in the appended claims.

What is claimed is:

1. A remote monitoring transmitter comprising:
a video input terminal;
video compressing means for compressing at a variable compression ratio video data input through said video input terminal;
a communication interface for conducting communications over a network; and
controlling means for causing said video compressing means to control said compression ratio based upon receipt by said communication interface of control data for controlling said compression ratio for said video data;
wherein video data compressed by said video compressing means are transmitted through said communication interface.

2. A remote monitoring transmitter according to claim 1, wherein said video compressing means varies said compression ratio by having a quantization step value updated.

3. A remote monitoring transmitter according to claim 1, wherein video data furnished with an address header including an IP address of a receiver are transmitted through said communication interface.

4. A remote monitoring receiver comprising:
a communication interface for conducting communications over a network;
a plurality of video decompressing means for decompressing a plurality of sets of video data received through said communication interface;
video splitting means which, given said plurality of sets of video data decompressed by said video decompressing means, generates video data in such a manner as to display pictures constituted by the decompressed video data in split-area fashion on a single monitor screen;
a video output terminal for outputting said video data generated by said video splitting means;
operating means for selecting any of said video data representative of said plurality of sets of video data for an enlarged display on said single monitor screen; and
controlling means which, based on operations performed on said operating means, controls said video splitting means and transmits through said communication interface control data for controlling a compression ratio for said video data.

5. A remote monitoring receiver according to claim 4, wherein said controlling means transmits as said control data those for updating a quantization step value.

6. A remote monitoring receiver according to claim 4, wherein video data furnished with an address header including an IP address of said remote monitoring receiver are received through said communication interface.

7. A remote monitoring system comprising a plurality of remote monitoring transmitters and a remote monitoring receiver;
wherein each of said remote monitoring transmitters includes:
a video input terminal;
video compressing means for compressing at a variable compression ratio video data input through said video input terminal;
a communication interface for conducting communications over a network; and
controlling means for causing said video compressing means to control said compression ratio based upon receipt by said communication interface of control data for controlling said compression ratio for said video data;
wherein video data compressed by said video compressing means are transmitted through said communication interface over said network to said remote monitoring receiver;
wherein said remote monitoring receiver includes:
a communication interface for conducting communications over said network;
a plurality of video decompressing means which correspond to said remote monitoring transmitters on a one-to-one basis and which decompress a plurality of sets of video data received through said communication interface from said remote monitoring transmitters;
video splitting means which, given said plurality of sets of video data decompressed by said video decompressing means, generates video data in such a manner as to display pictures constituted by the decompressed video data in split-area fashion on a single monitor screen;
a video output terminal for outputting said video data generated by said video splitting means;
operating means for selecting any of said video data representative of said plurality of sets of video data for an enlarged display on said single monitor screen; and
controlling means which, based on operations performed on said operating means, controls said video splitting means and transmits through said communication interface control data for controlling said compression ratio for said video data.

8. A remote monitoring system according to claim 7,
wherein said video compressing means of each of said remote monitoring transmitters varies said compression ratio by having a quantization step value updated; and
wherein said controlling means of said remote monitoring receiver transmits as said control data those for updating said quantization step value.
